(19) United States
(12) Patent Application Publication
(10) Pub. No.: US 2022/0057269 A1
(43) Pub. Date: Feb. 24, 2022

(54) MULTI-SENSOR USING A THERMAL CAMERA

(71) Applicant: Analog Devices, Inc., Wilmington, MA (US)

(72) Inventors: Krishnan Ramaswamy Parameswaran, Billerica, MA (US); Harvey Weinberg, Sharon, MA (US)

(21) Appl. No.: 17/403,299

(22) Filed: Aug. 16, 2021

Related U.S. Application Data
(60) Provisional application No. 63/068,755, filed on Aug. 21, 2020.

(51) Int. Cl. G01J 5/00; G06K 9/00; H04N 5/232; G06K 9/46; G01J 5/12; B60W 40/08; B60R 1/00

(52) U.S. Cl. CPC G01J 5/0025; G06K 9/00845; H04N 5/23299; G06K 9/4604; H04N 5/23245; G01J 5/12; B60R 2300/10; B60R 1/00; G01J 2005/0077; G01J 2005/123; B60W 2420/42; B60W 2420/40; B60R 2300/20; B60W 40/08

(57) ABSTRACT

An infrared thermal camera can be installed in a vehicle, such as a car, to provide different capabilities including night vision, passenger temperature monitoring, liveness detection, and avoidance of collisions with animals. The camera may be located inside the vehicle facing outwards through the front windshield. The camera may be used in multiple modes. In a first mode, the camera may be used to provide night vision or other thermal imaging of a scene outside the vehicle using a first field of view. In a second mode, the camera may be used to provide thermal imaging of a scene at least partially inside the vehicle using a second field of view, which may be useful, for example, for scanning the skin temperatures of occupants.

### CLAIMS OF PRIORITY

This patent application claims the benefit of priority U.S. Provisional Patent Application Ser. No. 63/068,755, titled “MULTI-SENSOR USING A THERMAL CAMERA,” filed on Aug. 21, 2020, which is hereby incorporated by reference herein in its entirety.

### TECHNICAL FIELD

The present disclosure generally describes infrared thermal camera inside a vehicle operating in multiple modes.

### BACKGROUND

Vehicles have been increasing their functionality at a rapid pace recently. Vehicles can access information from a plurality of different sources. Automotive applications of infrared technology have been growing in number and scope over the past several years. For example, some cars can employ infrared cameras to provide night vision views to the driver (e.g., automotive night vision). But these use cases of infrared cameras in vehicles have been limited in their scope and capabilities.

### BRIEF DESCRIPTION OF THE DRAWINGS

Various ones of the appended drawings merely illustrate example embodiments of the present disclosure and should not be considered as limiting its scope.

FIG. 1 illustrates a block diagram of a vehicle equipped with an infrared thermal camera.

FIG. 2A is a side view of a block diagram of a vehicle equipped with an infrared thermal camera and an optical system.

FIG. 2B is a top view of a block diagram of a vehicle equipped with an infrared thermal camera and an optical system

FIG. 3 illustrates a flow diagram of a method for operating an infrared thermal camera system.

FIG. 4A illustrates a side view of an example of a thermopile sensor pixel.

FIG. 4B illustrates a top view of an example of a thermopile sensor pixel.

### DETAILED DESCRIPTION

An infrared thermal camera can be installed in a vehicle, such as a car, to provide different capabilities including night vision, passenger temperature monitoring, liveness detection, and avoidance of collisions with animals. The camera may be located inside the vehicle facing outwards through the front windshield. The camera may be used in multiple modes. In a first mode, the camera may be used to provide night vision or other thermal imaging of a scene outside the vehicle using a first field of view. In a second mode, the camera may be used to provide thermal imaging of a scene at least partially inside the vehicle using a second field of view, which may be useful, for example, for scanning the skin temperatures of occupants. Thus, the same imaging sensor or imaging system may be used to provide imaging functionality directed both outside and inside the vehicle.

This document describes a method for operating an infrared camera in multiple modes. The method includes: operating the infrared camera located inside a vehicle in a first mode with a first field of view to capture at least one image of outside the vehicle; detecting an indication; based on detecting the indication, operating the infrared camera in a second mode with a second field of view to capture at least one image of inside the vehicle; and based on the at least one image of inside the vehicle, detecting skin temperature of an occupant inside the vehicle.

This document also describes a system for providing multiple imaging modes. The system includes an infrared camera mounted inside a vehicle to operate in two modes: in a first mode, to capture at least one image of outside the vehicle using a first field of view, and in a second mode, to capture at least one image of inside the vehicle using as second field of view and, based on the at least one image of inside the vehicle, to detect skin temperature of an occupant inside the vehicle.

This document further describes a camera system. The camera system includes an infrared camera configured to be mounted inside a vehicle providing a first field of view to capture at least one image of outside the vehicle in a first mode; an optical system configured to be mounted inside the vehicle between the infrared camera and a front windshield providing a second field of view for the infrared camera to capture at least one image inside the vehicle in a second mode; and a control circuit to switching operating the system between the first mode and second mode based on a detected condition and to detect skin temperature of an occupant based on the at least one image inside the vehicle.

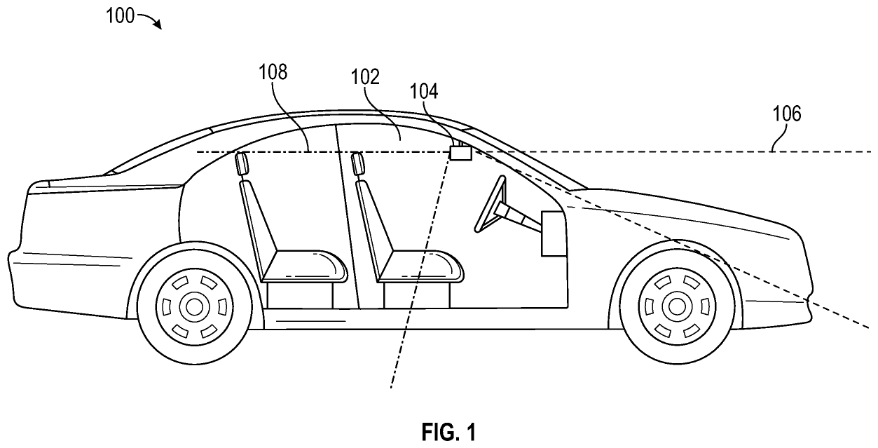

FIG. 1 illustrates a block diagram of a vehicle 100 equipped with an infrared thermal camera. The vehicle 100 may include a cabin 102 and an infrared thermal camera system 104 located inside the cabin, where passengers, including the driver, may be seated. The infrared thermal camera system 104 may be mounted on a center ceiling dome of the vehicle. In an example, the infrared thermal camera system 104 may be mounted near or integrated with the rear-view mirror of a vehicle. The infrared thermal camera system 104 may be positioned so that it is facing outwards through the front windshield. As described in further detail below, the infrared thermal camera system 104 may include a complementary metal-oxide-semiconductor (CMOS) imaging sensor or other infrared-sensitive solid-state imaging sensor.

The infrared thermal camera system 104 may operate in two modes. In a first mode, the infrared thermal camera system 104 may image a scene outside of the vehicle using a first field of view 106 to provide night vision or other thermal imaging. The first field of view 106 may be defined by a line of sight through the front windshield and may be set at approximately 70 degrees horizontally and 30 degrees vertically. This first mode may be used when the vehicle is in motion to detect hard-to-see things like pedestrians or animals at night, for example. The vehicle 100 may also include a display (not shown) to display a thermal image of the view in front of the vehicle.

In a second mode, the infrared thermal camera system 104 may image a scene at least partially inside of the vehicle (i.e., cabin 102) using a second field of view 108. The second field of view 108 may be larger than the first field of view 106 to capture a wider area inside of the vehicle 100 as compared to outside the vehicle 100. This second mode may be used to detect skin temperatures of the occupants to determine, for example, if any of the occupants have a fever. This second mode may also be used to scan the skin temperatures to determine whether the air temperature in the cabin 102 should be changed, e.g., increasing or decreasing the air conditioning or heating. The second mode may also be used to detect occupants left in the vehicle, e.g., children, pets, after the vehicle has been turned off.

A control circuit (e.g., processor) may be coupled to the infrared thermal camera system 104 to switch between the first and two modes based on a detected condition, as described in further detail below. Moreover, the control circuit may detect the skin temperatures of the occupants inside the vehicle, as described in further detail below.

Different mechanisms may be used to implement the infrared thermal camera system 104 operating in the two modes. For example, the infrared thermal camera system 104 may be mounted on a rotating platform, which can rotate the infrared thermal camera system 104 to face the front windshield in the first mode and the cabin 102 in the second mode. In other implementations, the infrared camera may remain stationary, and its field of view may be changed, for example, by using optical components.

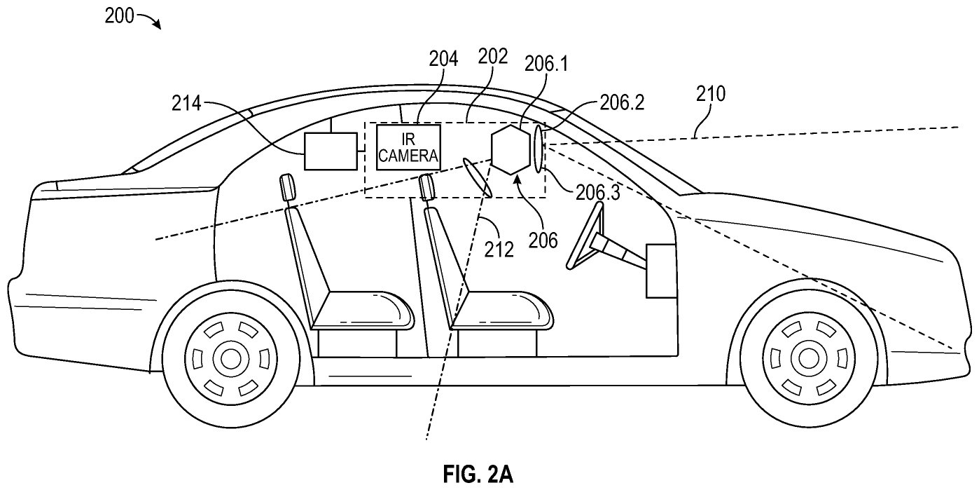

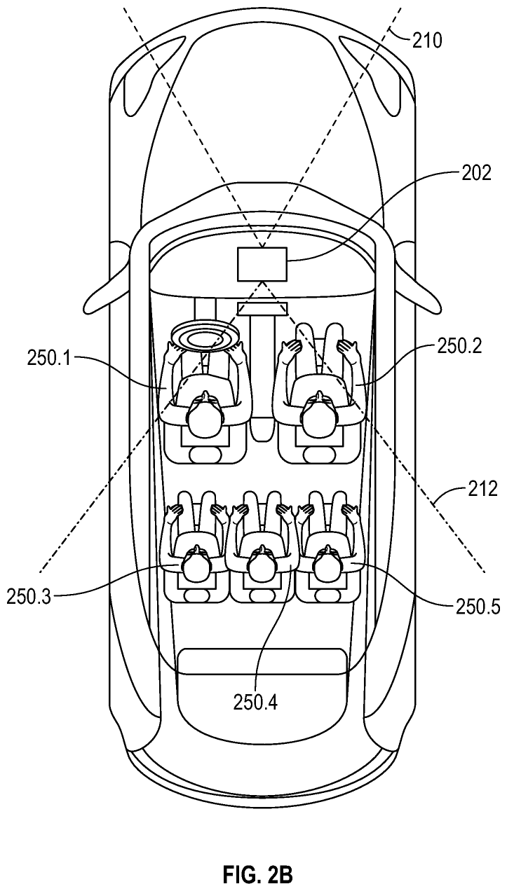

FIGS. 2A and 2B illustrate a block diagram of a vehicle 200 equipped with an infrared thermal camera and an optical system. FIG. 2A is a side view of the vehicle 200 while FIG. 2B is a top view of the vehicle 200. The vehicle 200 may include an infrared thermal camera system 202, which may include an infrared thermal camera 204 and optical system 206. The infrared thermal camera 204 may be mounted on a center ceiling dome of the vehicle 200. In an example, the infrared thermal camera 204 may be mounted near or integrated with the rear-view mirror of a vehicle. The infrared thermal camera system 204 may be positioned so that it is facing outwards through the front windshield. As described in further detail below, the infrared thermal camera system 104 may include a complementary metal-oxide-semiconductor (CMOS) imaging sensor or other infrared-sensitive solid-state imaging sensor.

The optical system 206 may be mounted adjacent to the to the infrared thermal camera 204. The optical system 206 may be positioned between the infrared thermal camera 204 and the front windshield of the vehicle 200. The optical system 206 may include transmissive and/or reflective optical components. The optical system 206 may redirect the field of view of the infrared thermal camera 204 from outside the vehicle 200 to inside the vehicle 200, such as toward the passenger cabin of the vehicle. Thus, the infrared thermal camera 204 may collect thermal signals from outside the car (e.g., in night vision mode) in a first mode and from inside the car (e.g., in temperature detection mode) in a second mode simultaneously and without physically moving the infrared thermal camera 204.

The optical system 206 may be mounted on a motorized stage with a galvanometer or a non-mechanical beam steering optic such as an electro-optic liquid crystal to modify the field of view based on the mode of the infrared thermal camera 204. The optical system 206 may redirect and enlarge the field of view of the infrared thermal camera 204. The optical system 206 may include multi-faceted optics (e.g., silicon, germanium, ZnSe). The optical system may include a non-mechanical beam steering element. For example, the optical system may include a combination of one or more mirrors and one or more prisms. For example, the optical system 206 may include a prism 206.1 and focusing lenses 206.2, 206.3. For the first mode, the field of view of the thermal infrared camera 204 may focus on a transmissive (i.e., non-reflective) surface of the prism 206.1 and the focusing lens 206.2 to capture an image from the outside field of view 210. For the second mode, the field of view of the thermal infrared camera 204 may focus on a reflective surface of the prism 206.1 and the focusing lens 206.3 to capture an image from the inside field of view 212. The inside field of view 212 may be larger than the outside field of view 210 to capture a wider area inside of the vehicle 200 as compared to outside the vehicle 200. For example, in the second mode, the thermal infrared camera 204 may scan the temperatures of occupants 250.1-250.5 of the vehicle.

A control circuit (e.g., processor) may be coupled to the infrared thermal camera system 202 to switch between the first and two modes based on a detected condition, as described in further detail below. Moreover, the control circuit may detect the skin temperatures of the occupants inside the vehicle, as described in further detail below.

The vehicle 200 may also include a detector 214 mounted inside the cabin. The detector 214 may be provided as an acoustic or RADAR detector. The detector 214 may be used to detect the presence of an occupant, e.g., children, pets, after the vehicle has been turned off.

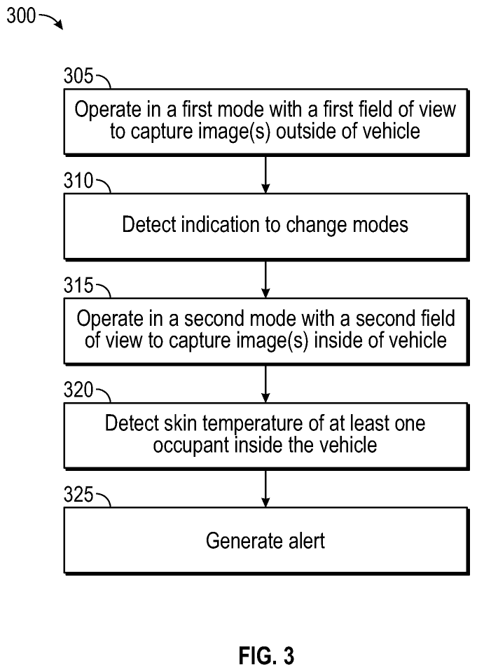

FIG. 3 illustrates a flow diagram of a method 300 for operating an infrared thermal camera system. Method 300, for example, may be performed by the infrared thermal camera systems located inside of a vehicle as described herein, e.g., in FIGS. 1 and 2.

At 305, the camera system may operate in a first mode with a first field of view to capture one or more images outside of a vehicle. For example, the camera system may operate in night vision mode during night and poor weather (e.g., conditions with limited light outside). The camera system may capture images of objects outside the vehicle facing the front windshield. The images may be stored and reproduced on a display inside the vehicle to provide a thermal image of the view in front of the car when visibility is low (e.g., periods of darkness due to night or poor weather). The first field of view may be defined by a line of sight through the front windshield and may be set at approximately 70 degrees horizontally and 30 degrees vertically.

At 310, an indication may be detected for changing modes. The indication may represent one or more changes in the vehicle and/or environment. For example, the indication may be the detection of daylight (e.g., driving during the day when night vision may not be needed). In another example, the indication may be the detection of a door opening and/or closing in the vehicle, which may indicate new occupants in the vehicle. In another example, the indication may be the vehicle ignition or accessory power being engaged or disengaged. In another example, the indication may be detecting whether the vehicle is stationary. In another example, the indication may be switching the car into a drive gear (or a reverse gear) as indicated by a vehicle transmission state, as opposed to a parking gear. In another example, the indication may be a change in occupant seating. The indication may be one or a combination of two or more indications described herein.

At 315, based on a detected indication, the camera system may operate in a second mode with a second field of view to capture one or more images inside of the vehicle (e.g., of the passenger cabin). For example, the camera system may detect thermal energy inside the vehicle. The second field of view may be larger than the first field of view to capture a wider area inside of the vehicle as compared to outside the vehicle.

The camera system may switch from the first mode to second mode and vice versa with the use of an optical system as described herein. In this example, the field of view of the camera may be changed without physically moving the camera. The optical system may redirect and enlarge the field of view. In another example, to change the field of view, the camera itself may be rotated via a motor.

At 320, based on the one or more images captured inside the vehicle, skin temperature of one or more occupants of the vehicle may be detected. Based on one or more images of inside the vehicle, an outline of the one or more occupants inside the vehicle may be determined. For example, a Hough transform may be performed to determine the outline of the one or more occupants. The one or more images may include thermal readings. Those thermal readings may be laid over the generated outline of the occupants. From this overlay, a forehead location (or other suitable, accessible location) of the one or more occupants may be detected and selected, and the thermal reading for the selected location of the one or more occupants may be determined. This thermal reading from the selected location may represent the skin temperature of the occupant. In an example, this thermal reading may indicate whether that occupant has a fever.

Moreover, in the event the vehicle is turned off (e.g., accessory power disengaged or ignition disengaged), the temperature reading may indicate the presence of an occupant, such as a child, pet, etc., remaining in the car. Detection of living beings may be supported with another detector. For example, an acoustic or RADAR detector may also be used in conjunction with the camera system described herein in response to a car turning off to detect the presence of a living being. Information from the acoustic or RADAR detector and the camera system may be collected and from this information, it may be determined if a living being is present in the car after it has been turned off.

At 325, an alert or notification may be generated. A notification may be sent based on the temperature reading. For example, the notification may alert the driver that one of the occupants has a fever and identify which occupant. In another example, a notification may be sent to another device, such as a mobile phone, alerting the user that an occupant (e.g., child, pet, etc.) remains in the car after the car was turned off. In another example, based on the temperature reading, the air conditioning/heating unit may adjust the temperature setting automatically.

The thermal IR camera described herein may include a microbolometer or thermopile sensor array. For example, the thermopile sensor array may be provided using the techniques described in the publication David Kryskowski, “Small pitch high performance thermopile focal plane arrays,” Proc. SPIE 8012, Infrared Technology and Applications XXXVII, 80123W (21 May 2011); doi: 10.117/12.883710, which is incorporated herein by reference in its entirety, including but not limited to those portions that specifically appear hereinafter, the incorporation by reference being made with the following exception: In the event that any portion of the above-referenced publication is inconsistent with this application, this application supersedes the above-referenced publication.

Moreover, the thermopile sensor array may include patterned structures for focusing and anti-reflection properties using the techniques described in U.S. application Ser. No. 17/103,473, entitled “Optical Element with Diffractive Focusing Features and Diffractive Features,” filed on Nov. 24, 2020, claiming priority to U.S. Provisional Application No. 62/940,668 filed Nov. 26, 2019, which is incorporated herein by reference in its entirety, including but not limited to those portions that specifically appear hereinafter, the incorporation by reference being made with the following exception: In the event that any portion of the above-referenced application is inconsistent with this application, this application supersedes the above-referenced application.

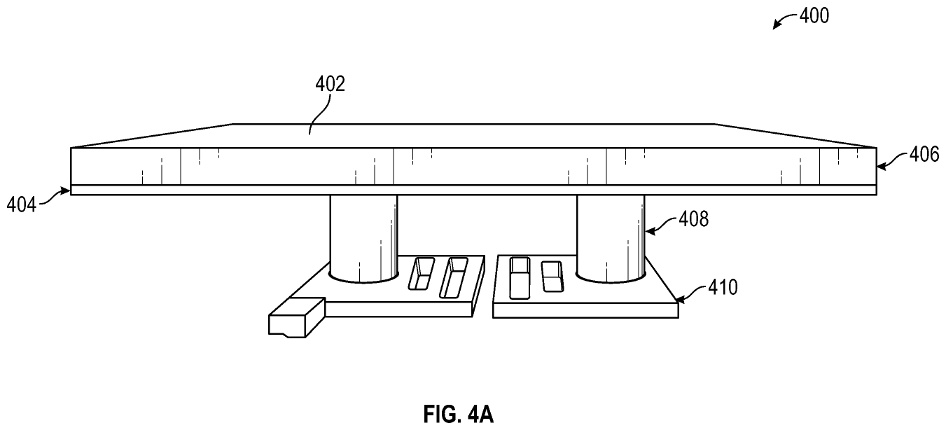

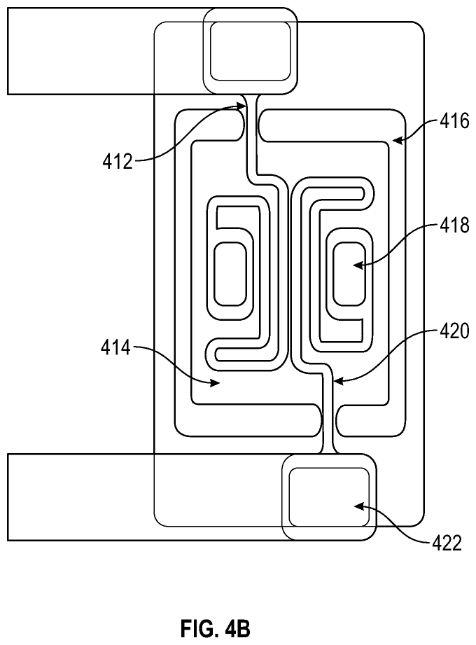

FIG. 4A illustrates a side view of an example of a thermopile sensor pixel 400. The thermopile sensor pixel 400 may include a top surface 402 (e.g., Palladium (Pd FSS) surface), a mirror 404 (e.g., Pd mirror), a spacer 406 (e.g., Germanium (Ge) spacer), a plug post (e.g., tungsten (W) plug post 408, and an epitaxial surface 410 (e.g., epitaxial SiGe (Silicon Germanium)).

FIG. 4B illustrates a top view of the thermopile sensor pixel 400. The thermopile sensor 400 may also include a p-type epitaxial surface 412 (e.g., p-type epitaxial SiGe), a release tab 414 (e.g., Si release tab), an etch stop 416 (e.g., tetraethyl orthosilicate (TEOS) etch stop), a post platform 418, a n-type epitaxial surface 420 (e.g., n-type epitaxial SiGe), and an electrical contact 422.

Thermopile sensors measure temperature through the semiconductor thermoelectric effect, where heat absorbed by the top surface 402 is conducted to the sensing elements of the epitaxial surface 410 through posts 408. The p- and n-type semiconductor (e.g., epitaxial doped SiGe) form a junction of dissimilar materials where a voltage proportional to the absolute junction temperature is generated. This signal is passively generated and requires no applied bias. The serpentine SiGe structure is formed using a microfabrication process and is designed to minimize heat loss and maximize electrical conduction of the signal to the readout circuit (not shown in the figure). Arrays of thermopiles can be connected in series to increase the signal level of a point sensor. Alternatively, an array connected in parallel enables measurement of a two-dimensional image when combined with a suitable readout circuit.

As described herein, the elements of the sensor array may each have a spectral filter, which may be provided on the top surface of each pixel in the array. Thus, each pixel may detect a slightly different wavelength band. The combination of the readings from each pixel may therefore provide more accurate temperature readings of occupants inside the car.

### Various Notes

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific implementations in which the invention can be practiced. These implementations are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other implementations can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed implementation. Thus, the following claims are hereby incorporated into the Detailed Description as examples or implementations, with each claim standing on its own as a separate implementation, and it is contemplated that such implementations can be combined with each other in various combinations or permutations. The scope of the invention should be determined with reference to the appended claims, along with the full scope of equivalents to which such claims are entitled.

1. A method for operating an infrared camera in multiple modes, comprising:
operating the infrared camera located inside a vehicle in a first mode with a first field of view to capture at least one image of outside the vehicle;
detecting an indication;
based on detecting the indication, operating the infrared camera in a second mode with a second field of view to capture at least one image of inside the vehicle; and
based on the at least one image of inside the vehicle, detecting skin temperature of an occupant inside the vehicle.

2. The method of claim 1, wherein operating in the second mode comprises:
using an optical system to change from the first field of view to the second field of view.

3. The method of claim 1, wherein the change from the first field of view to second field of view is performed without physically moving the infrared camera.

4. The method of claim 1, wherein the second field of view is wider than the first field of view.

5. The method of claim 1, further comprising:
based on the at least one image of inside the vehicle, determining an outline of the occupant;
overlaying thermal readings from the infrared camera over the outline of the occupant;
selecting a location on the occupant to detect skin temperature; and
based on the overlain thermal readings at the selection location, determining the skin temperature of the occupant.

6. The method of claim 4, wherein the location includes a forehead of the occupant.

7. The method of claim 4, further comprising:
determining the skin temperature of another occupant in the vehicle using the at least one image.

8. The method of claim 1, wherein the infrared camera includes an array of thermopile sensors.

9. The method of claim 8, wherein each pixel of the array of thermopile sensors detects a different wavelength band.

10. A system for providing multiple imaging modes, the system comprising:
an infrared camera mounted inside a vehicle to operate in two modes:
in a first mode, to capture at least one image of outside the vehicle using a first field of view, and
in a second mode, to capture at least one image of inside the vehicle using as second field of view and, based on the at least one image of inside the vehicle, to detect skin temperature of an occupant inside the vehicle.

11. The system of claim 10, further comprising:
an optical system to change from the first field of view to the second field of view.

12. The system of claim 11, wherein the optical system includes a non-mechanical beam steering element.

13. The system of claim 10, wherein the second field of view is wider than the first field of view.

14. The system of claim 10, further comprising a processor to:
based on the at least one image of inside the vehicle, determine an outline of the occupant;
overlay thermal readings from the infrared camera over the outline of the occupant;
select a location on the occupant to detect skin temperature; and
based on the overlain thermal readings at the selection location, determine the skin temperature of the occupant.

15. The system of claim 10, wherein the infrared camera includes an array of thermopile sensors.

16. The system of claim 15, wherein each element of the array of thermopile sensors includes a spectral filter to detect a different wavelength band.

17. A camera system, comprising:
an infrared camera configured to be mounted inside a vehicle providing a first field of view to capture at least one image of outside the vehicle in a first mode;
an optical system configured to be mounted inside the vehicle between the infrared camera and a front windshield providing a second field of view for the infrared camera to capture at least one image inside the vehicle in a second mode; and
a control circuit to switching operating the system between the first mode and second mode based on a detected condition and to detect skin temperature of an occupant based on the at least one image inside the vehicle.

18. The system of claim 17, wherein the infrared camera includes an array of thermopile sensors.

19. The system of claim 18, wherein each element of the array of thermopile sensors includes a spectral filter to detect a different wavelength band.

20. The system of claim 17, further comprising:
a display to display the at least one image of outside the vehicle.
